(19) United States
(12) Patent Application Publication
(10) Pub. No.: US 2012/0324695 A1
(43) Pub. Date: Dec. 27, 2012

(54) EXTENSION TOOLING APPARATUS

(75) Inventors: David Taro Morikawa, Burlington (CA); Bernard Argos Majarais, Brampton (CA); Radomir Radivojcevic, Toronto (CA); Robert McMullan, Etobicoke (CA)

(73) Assignee: PROMATION NUCLEAR LTD., Oakville (CA)

(21) Appl. No.: 13/528,945

(22) Filed: Jun. 21, 2012

Related U.S. Application Data
(60) Provisional application No. 61/500,312, filed on Jun. 23, 2011.

(51) Int. Cl. B25G 1/00; B23P 11/00; B25G 1/04

(52) U.S. Cl. 29/426.5; 81/489; 173/213; 81/53.1; 173/1; 29/456

(57) ABSTRACT

An extension tooling apparatus can include a delivery portion and a control portion. The delivery portion can include a base element mountable to a fixed surface, an arm pivotably coupled to the base element, and a tool attachment coupled to a tool end of the arm. The control portion can include a shank, a tip member joined to a tip end of the shank, and a collar adjacent a distal end of the tip member. The collar can support the tool attachment of the delivery portion so that positioning of the tool attachment is controllable by movement of the shank. The extension tooling apparatus can be useful for manipulating nuts, bolts, and other hardware from a distance.

### CROSS REFERENCE TO RELATED APPLICATION

This application claims priority to U.S. Provisional Application No. 61/500,312 filed on Jun. 23, 2011 and entitled EXTENSION TOOLING APPARATUS, the entire contents of which are hereby incorporated herein by reference.

### FIELD

The present disclosure relates to tooling apparatuses for and methods of manipulating nuts, bolts, and other hardware. The present disclosure also relates to nuclear reactor technology.

### BACKGROUND

The following paragraphs are not an admission that anything discussed in them is prior art or part of the knowledge of persons skilled in the art.

In a CANDU nuclear reactor, fuel bundles reside in horizontal fuel channels. Heat from the fuel bundles is transferred to heavy water flowing through the fuel channels. The heavy water is passed through a steam generator, which creates steam to power a steam turbine and generate electricity. The heavy water is then looped back to the fuel channels. The steam generator includes a lower bowl, which contains a divider plate. The divider plate separates the hot leg from the cold leg of the heavy water loop.

In some reactors, the divider plate is manufactured from several smaller plates that are bolted together. Up to eighty or more nuts and bolts can be used to fasten the plates together, and restrained using locking tabs or other locking devices. Components of the divider plate can also include corner clamping plates, or clamping dogs.

### INTRODUCTION

The following paragraphs are intended to introduce the reader to the more detailed description that follows and not to define or limit the claimed subject matter.

According to an aspect of the present disclosure, an extension tooling apparatus can include: a delivery portion, the delivery portion including a base element mountable to a fixed surface, an arm pivotably coupled to the base element, the arm extending along an arm length between a fixed end adjacent the base element and a tool end opposite the fixed end, and a tool attachment coupled to the tool end of the arm; and a control portion, the control portion including a shank extending lengthwise along a shank axis between a handle end and a tip end, a tip member joined to the tip end of the shank, the tip member extending between a proximal end adjacent the shank and a distal end opposite the proximal end, and a collar adjacent the distal end of the tip member, the collar supporting the tool attachment of the delivery portion so that positioning of the tool attachment is controllable by movement of the shank.

According to an aspect of the present disclosure, a method of manipulating a hardware component can include: providing a delivery portion, the delivery portion comprising an arm and a tool attachment coupled to a tool end of the arm; providing a control portion, the control portion comprising a shank and a collar coupled to a tip end of the shank, the collar supporting the tool attachment of the delivery portion; and controlling movement of the shank to position the tool attachment at the hardware component.

According to an aspect of the present disclosure, an extension tooling apparatus can include: a shank extending lengthwise along a shank axis between a handle end and a tip end; a tip member joined to the tip end of the shank, the tip member extending between a proximal end adjacent the shank and a distal end opposite the proximal end; a collar adjacent the distal end of the tip member, the collar for supporting a tool attachment so that positioning of the tool attachment is controllable by movement of the shank; and an actuator shaft fixed to the collar and extending lengthwise of the shank to the handle end, the actuator shaft being adapted to rotate relative to the shank to cause corresponding rotation of the collar about the tip member.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIGS. 1A and 1B are perspective views of an extension tooling apparatus;

FIGS. 2A and 2C are detailed perspective views of a part of the extension tooling apparatus;

FIG. 2B is a sectional view along line 2B-2B in FIG. 2A;

FIGS. 3A and 3B are perspective views of the extension tooling apparatus, shown with a lower bowl and a divider plate of a steam generator;

FIGS. 4A to 4F are a series of views showing various positions of the extension tooling apparatus relative to the divider plate;

FIGS. 5A to 5C are perspective views of tool attachments coupled to the extension tooling apparatus; and

FIG. 6 shows an extension tooling apparatus in use manipulating a bolt of a divider plate.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

Nuts, bolts, locking tabs, corner clamping plates, clamping dogs, and other hardware associated with a divider plate of a steam generator can occasionally require repair, including replacement. Repair can be a manual process, and can be carried out using hand tools, from within a lower bowl of the steam generator used in a CANDU nuclear reactor. Manual repair can expose workers to radiation and poses a health risk. The teachings herein relate to an extension tooling apparatus configured for manipulating hardware to repair the divider plates from a distance, outside the lower bowl of the steam generator.

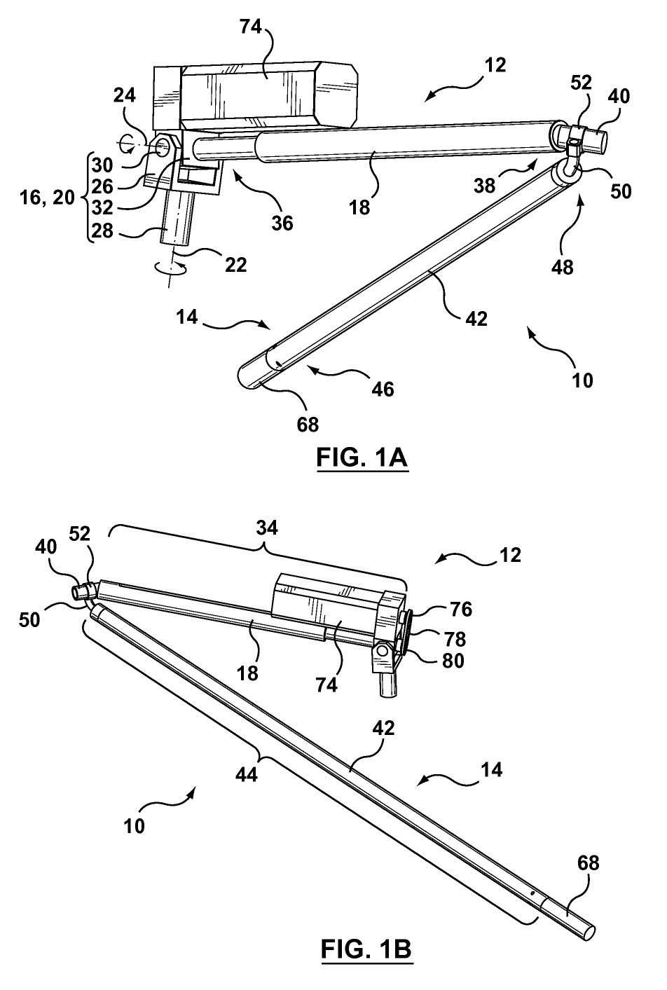

Referring to FIGS. 1A and 1B, an extension tooling apparatus is shown generally at 10. The extension tooling apparatus 10 includes a delivery portion 12 and a control portion 14.

The delivery portion 12 includes a base element 16 that is mountable to a fixed surface (not yet shown). An arm 18 extends along an arm length 34 (see FIG. 1B) between a fixed end 36 adjacent the base element 16 and a tool end 38 opposite the fixed end 36. The arm 18 can include at least two portions configured for telescoping movement so that the arm length 34 is variable. The fixed end 36 is pivotably coupled to the base element 16. The delivery portion 12 further includes a tool attachment 40 that is coupled to the tool end 38 of the arm 18.

In the example illustrated, referring particularly to FIG. 1A, the base element 16 includes a yoke mechanism 20 that facilitates pivotal movement of the arm 18 about first and second axes 22, 24, which can be generally orthogonal. The yoke mechanism 20 includes a fork 26 mounted on a stem 28 that, once mounted to the fixed surface, allows rotation of the fork 26 about the first axis 22. A pin 30 retains a connecting block 32 between jaws of the fork 26, allowing pivoting of the connecting block 32 about the second axis 24. The fixed end 36 of the arm 18 is mounted to the connecting block 32.

In some examples, the base element can further include a counterbalance device (not shown) that is configured to apply force via the fixed end 36 of the arm 18 to offset the mass of the delivery portion 12. In some particular examples, a rotary actuator (not shown) can be arranged to apply a controlled amount of force to the connecting block 32, approximately balancing the weight of the delivery portion 12. The rotary actuator can be a pneumatic rotary actuator.

With continued reference to both FIGS. 1A and 1B, the control portion 14 includes a shank 42 that extends along a shank length 44 (see FIG. 1B) between a handle end 46 and a tip end 48. The shank 42 can be configured for telescoping movement so that the shank length 44 is variable. A tip member 50 is joined to the tip end 48 of the shank 42. The control portion 14 further includes a collar 52 adjacent the tip member 50. The collar 52 supports the tool attachment 40 of the delivery portion 12, so that positioning of the tool attachment 40 can be controlled by movement of the shank 42.

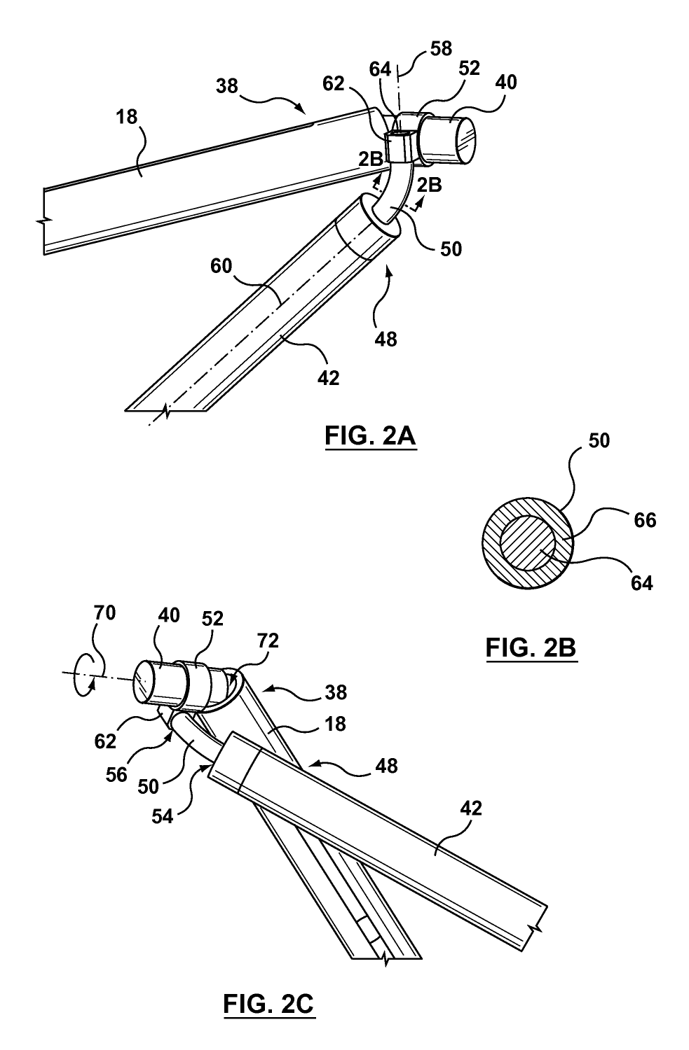

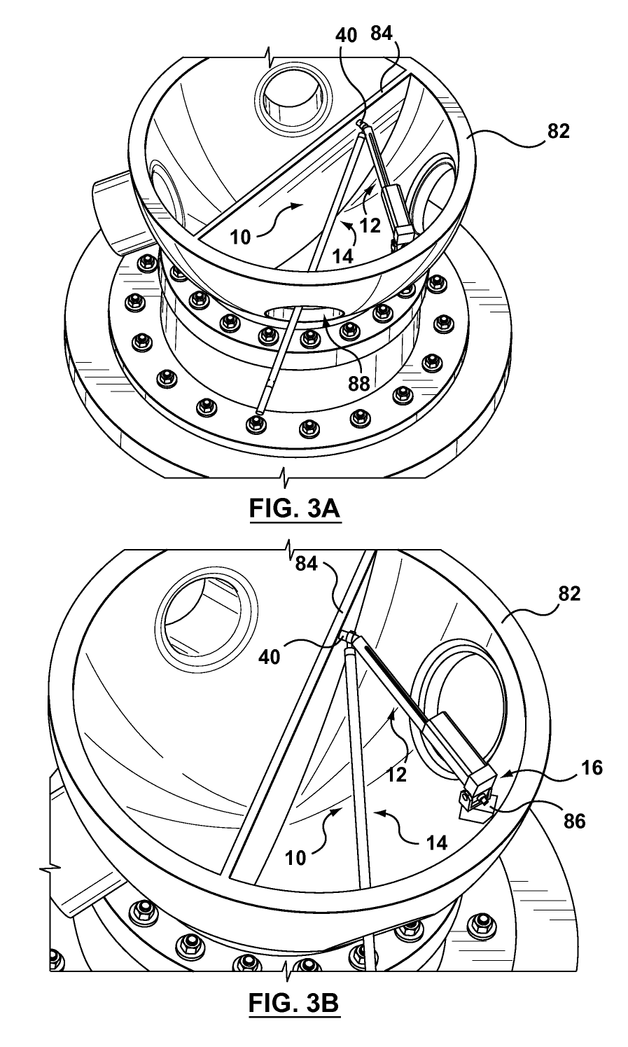

Referring now to FIGS. 2A to 2C, the tip member 50 extends between a proximal end 54 adjacent the shank 42 and a distal end 56 opposite the proximal end 54. In the example illustrated, the tip member 50 is formed in the shape of a curve so that the distal end 56 of the tip member 50 defines a tip axis 58 that is transverse to a shank axis 60 of the shank 42.

A boss 62 of the collar 52 is arranged adjacent the distal end 56 of the tip member 50. The control portion 14 further includes an actuator shaft 64 that is fixed to the boss 62 of the collar 52. Rotation of the actuator shaft 64 causes corresponding rotation of the collar 52 about the tip member 50. The actuator shaft 64 can be generally torsionally rigid but laterally flexible. The actuator shaft 64 can be formed of, for example, a flexible steel cable. The tip member 50 can include a generally tubular body 66, and the actuator shaft 64 is housed within the tubular body 66 (see FIG. 2B).

Although obscured from view in FIGS. 1A and 1B, it should be appreciated that the actuator shaft 64 can extend lengthwise of the shank 42 to the handle end 46. The control portion 14 can further include a handle 68 arranged at the handle end 46 of the shank 42. The handle 68 can be fixed to the actuator shaft 64 so that the actuator shaft 64 can be manually rotated by rotating the handle 68.

Although manual movement of the shank 42 and rotation of the actuator shaft 64 is described herein, it should be appreciated that, in other examples, movement of the shank 42 and rotation of the actuator shaft 64 can be automated through the implementation of suitable drive mechanisms (not shown) in the control portion 14. Further, in some other examples, it can be possible to automate movement of the arm 18 and control of the tool attachment 40 through the implementation of suitable drive mechanisms (not shown) in the delivery portion 12, with the control portion 14 omitted entirely. In such examples, drive mechanisms can be used to control the pivoting of the arm 18 about the axes 22, 24, vary the arm length 34, and control the angle of the tool attachment 40 relative to the arm 18, in addition to a drive mechanism 74 used to deliver torque to the tool attachment 40 via the arm 18, which is described below.

In some examples, referring back to FIGS. 2A and 2C, the collar 52 can allow rotation of the tool attachment 40 about a rotation axis 70. The rotation axis 70 can be generally perpendicular to the tip axis 58 defined by the distal end 56 of the tip member 50. In some particular examples, a circumferential recess (not shown) in the tool attachment 40 can receive the collar 52, so that the tool attachment 40 is free to rotate relative to the collar 52. In other examples, a pair of circumferential retaining rings can be used to retain the collar 52 on the tool attachment 40, while allowing the tool attachment 40 to rotate freely relative to the collar 52.

In some examples, the arm 18 can be rotated to drive rotation of the tool attachment 40. In such examples, if the arm 18 is arranged for telescoping movement, separate portions of the arm 18 can include a dowel and slot configuration so that the portions rotate in unison. The tool attachment 40 can be coupled to the arm 18 by a coupling 72 that transmits rotational movement from the arm 18 to the tool attachment 40. In some particular examples, the coupling 72 can take the form of a universal joint, which can allow the tool attachment 40 to pivot relative to the arm 18, as illustrated.

Referring back to FIGS. 1A and 1B, the delivery portion 12 can include the drive mechanism 74 for delivering a suitable amount of torque to the tool attachment 40 via the arm 18. The drive mechanism 74 can be remotely controlled. As seen in FIG. 1B, the drive mechanism 74 can include a first sprocket 76. A chain 78 can operably connect the first sprocket 76 with a second sprocket 80 that extends from the fixed end 36 of the arm 18. In such examples, it will be appreciated that the fixed end 36 of the arm 18 can be allowed to rotate relative to the connecting block 32. As an alternative to the sprockets 76, 80 and the chain 78, gears (not shown) can be used to transmit rotational movement from the drive mechanism 74 to drive the fixed end 36 of the arm 18.

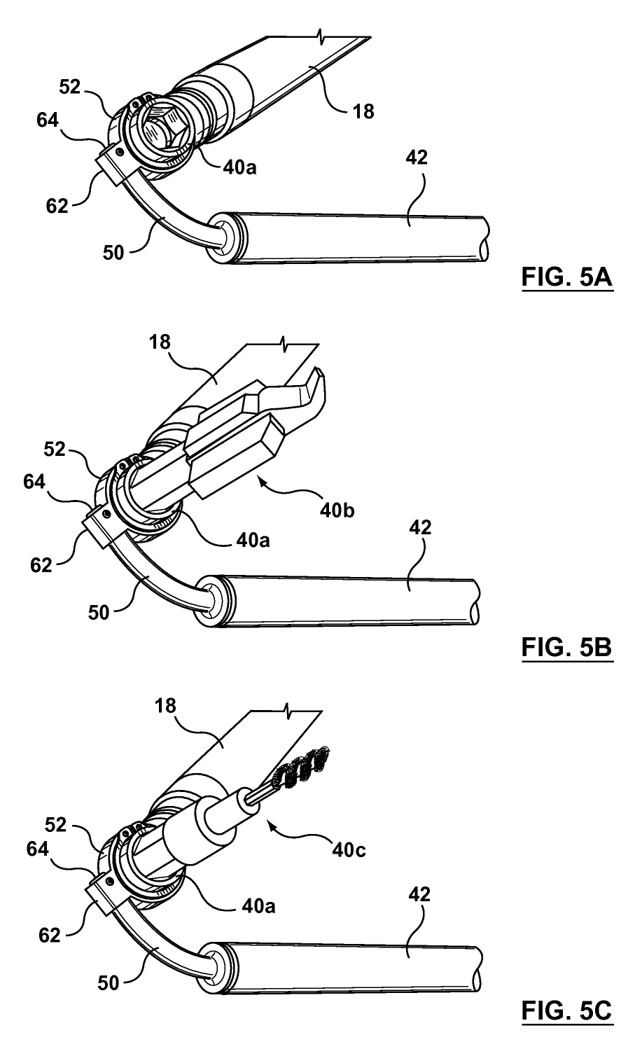

Skipping ahead to FIGS. 5A, 5B and 5C, the tool attachment 40 can take the form of various types of tools, including, for example but not intended to be limiting, a socket (shown in FIG. 5A at reference numeral 40a), a hook (shown in FIG. 5B at reference numeral 40b, and received in the socket 40a), a brush (shown in FIG. 5C at reference numeral 40c, and received in the socket 40a), a screwdriver head, a drill bit, a hammer, and a chisel.

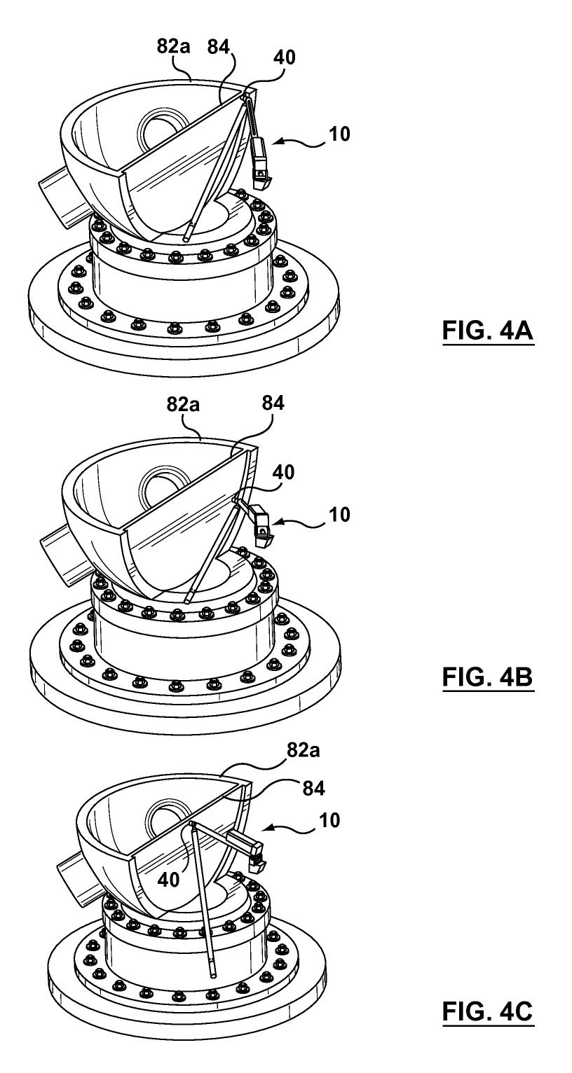

Referring now to FIGS. 3A and 3B, the extension tooling apparatus 10 is shown in combination with a lower bowl 82 and a divider plate 84 of a steam generator. In the example illustrated, the delivery portion 12 is mounted directly to a lug 86, which is a generally horizontal surface located at the back of the lower bowl 82, spaced apart from the divider plate 84. The lug 86 carries the reaction torque of the delivery portion 12, which can facilitate the delivery portion 12 being relatively lightweight.

Positioning of the tool attachment 40 of the delivery portion 12 can be manipulated using the control portion 14, which is shown extending out of a manway 88 of the lower bowl 82, which is typically the only means of accessing the interior of the lower bowl 82. Therefore, the extension tooling apparatus 10 can allow workers, located outside the lower bowl 82, to manipulate hardware to repair the divider plate 84. Depending on selection of an appropriate end effector as the tool attachment 40, it can be possible to use the extension tooling apparatus 10 to, for example, bend back locking tabs, remove bolts, remove nuts, clean threads or clearance holes in the divider plate 84, install new locking tabs, install new bolts, install new nuts, and torque the new nuts and bolts. It can also be possible to use the extension tooling apparatus 10 to remove clamping dogs, corner clamping plates, bend the new tabs, or removing seized nuts or bolts, depending on the tool attachment 40.

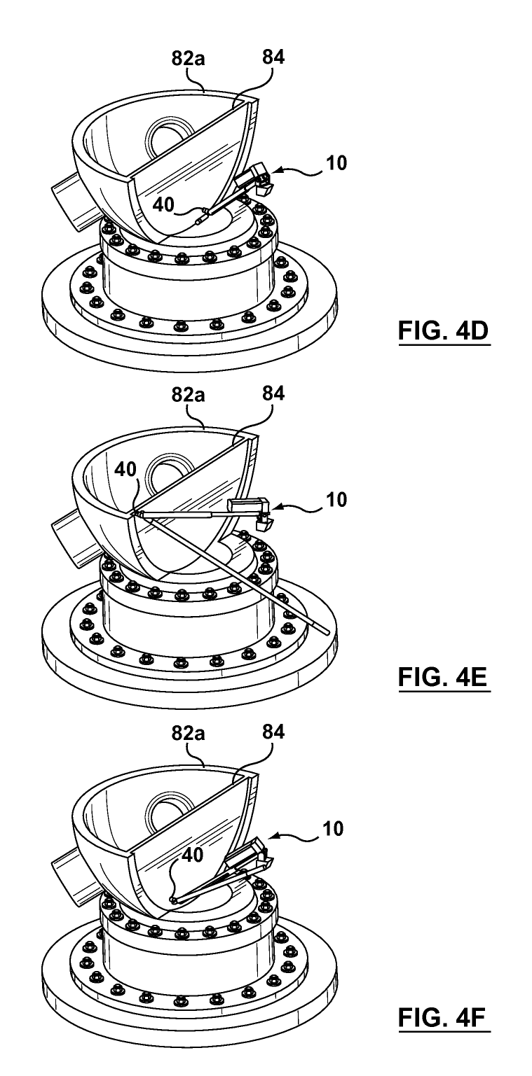

In FIGS. 4A to 4F, the lower bowl 82a is shown with half of it removed from view so as not to obscure the position of the extension tooling apparatus 10. As illustrated, the tool attachment 40 of the extension tooling apparatus 10 is capable of motion generally across the full face of the divider plate 84.

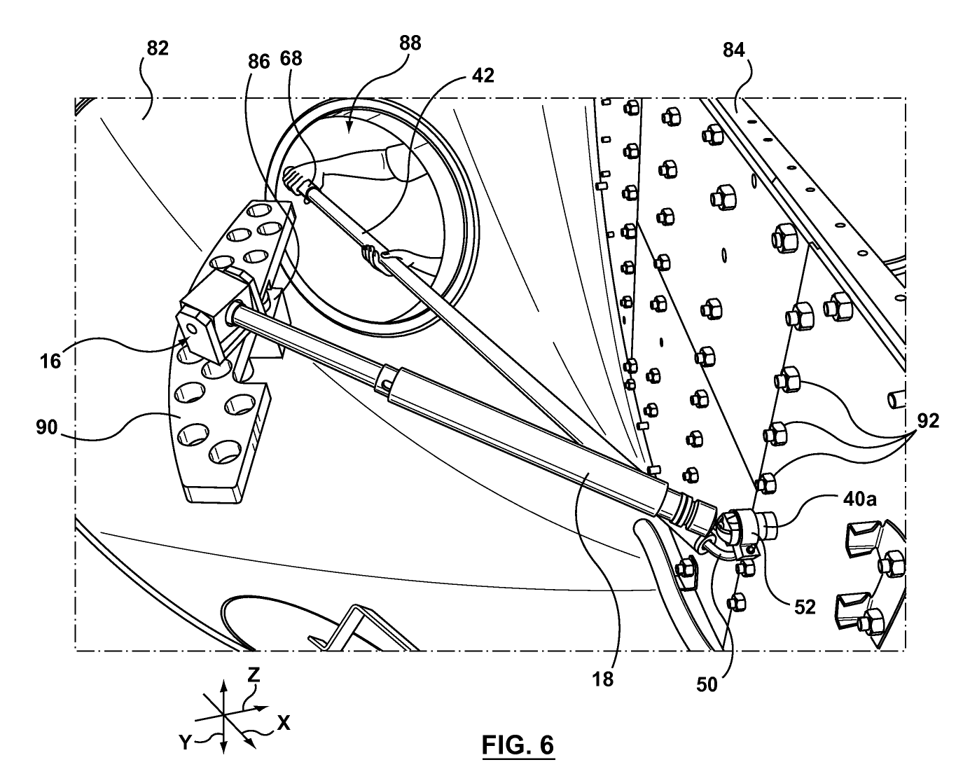

In the example shown in FIG. 6, the base element 16 is fixed to a plate 90, with the plate 90 mounted to the lug 86. The plate 90 is shown including a plurality of attachment holes allowing the location of the base element 16 to be varied within the lower bowl 82. Alternatively, a swing arm or a sliding arm (neither shown), or similar device could be used to couple the base element 16 to the lug 86.

As illustrated, the divider plate 84 includes a plurality of nuts/bolts 92. If the nuts/bolts 92 are aligned in a z-direction, then it should be appreciated that the nuts/bolts 92 can be removed and installed by applying torque about the z-direction. To access all of the nuts/bolts 92, the socket 40a can have motion generally across the full face of the divider plate 84 in x- and y-directions, and have motion in the z-direction.

The socket 40a is supported by the collar 52. The collar 52 allows the socket 40a to rotate freely. The collar 52 can be manipulated so that the angle of the socket 40a relative to the nuts/bolts 92 in the divider plate 84 can be controlled, i.e. the socket 40a can be aligned in the z-direction. This can be done by rotating the handle 68 at the end of the shank 42. The curve of the tip member 50 can allow desired angles to be achieved relatively simply and intuitively by the worker by moving the shank 42 and rotating the handle 68. The socket 40a can be engaged with a target one of the nuts/bolts 92, and rotated to cause the fastening or unfastening of the target one of the nuts/bolts 92.

Although this specification describes apparatuses and methods particularly in the context of steam generators in CANDU nuclear reactors, it should be appreciated that this description is provided by way of example only, and the present teachings are not limited as such. The teachings described herein can be used in a variety of applications, particularly in situations where hardware is located in hard to reach areas, and in an environment that poses health risks to workers.

While the above description provides examples of one or more processes or apparatuses, it will be appreciated that other processes or apparatuses may be within the scope of the accompanying claims.

We claim:

1. An extension tooling apparatus, comprising:
a delivery portion, the delivery portion comprising a base element mountable to a fixed surface, an arm pivotably coupled to the base element, the arm extending along an arm length between a fixed end adjacent the base element and a tool end opposite the fixed end, and a tool attachment coupled to the tool end of the arm; and
a control portion, the control portion comprising a shank extending lengthwise along a shank axis between a handle end and a tip end, a tip member joined to the tip end of the shank, the tip member extending between a proximal end adjacent the shank and a distal end opposite the proximal end, and a collar adjacent the distal end of the tip member, the collar supporting the tool attachment of the delivery portion so that positioning of the tool attachment is controllable by movement of the shank.

2. The apparatus of claim 1, wherein the control portion further comprises an actuator shaft fixed to the collar and extending lengthwise of the shank to the handle end.

3. The apparatus of claim 2, wherein rotation of the actuator shaft relative to the shank causes corresponding rotation of the collar about the tip member.

4. The apparatus of claim 3, wherein the tip member comprises a generally tubular body extending between the proximal end and the collar, and the actuator shaft is housed within the tubular body.

5. The apparatus of claim 4, wherein the actuator shaft is generally torsionally rigid and laterally flexible.

6. The apparatus of claim 5, further comprising a handle rotatably coupled to the handle end of the shank, the handle fixed to the actuator shaft so that the actuator shaft is manually rotatable by movement of the handle.

7. The apparatus of claim 1, wherein the tip member is formed in the shape of a curve so that the distal end of the tip member defines a tip axis that is transverse to the shank axis.

8. The apparatus of claim 1, wherein the collar allows rotation of the tool attachment about a rotation axis that is generally perpendicular to a tip axis defined by the distal end of the tip member.

9. The apparatus of claim 8, wherein the tool attachment is coupled to the arm by a coupling that transmits rotational movement from the arm to the tool attachment.

10. The apparatus of claim 9, wherein the tool attachment is configured to pivot relative to the arm.

11. The apparatus of claim 10, wherein the coupling comprises a universal joint.

12. The apparatus of claim 10, further comprising a drive mechanism for driving rotation of the tool attachment.

13. The apparatus of claim 1, wherein the base element comprises a yoke mechanism that facilitates pivotal movement of the arm about first and second axes.

14. The apparatus of claim 1, wherein the arm is configured for telescoping movement so that the arm length is variable.

15. The apparatus of claim 1, wherein the tool attachment comprises one of a socket, a hook, and a brush.

16. A method of manipulating a hardware component, comprising:
providing a delivery portion, the delivery portion comprising an arm and a tool attachment coupled to a tool end of the arm;
providing a control portion, the control portion comprising a shank and a collar coupled to a tip end of the shank, the collar supporting the tool attachment of the delivery portion; and
controlling movement of the shank to position the tool attachment at the hardware component.

17. The method of claim 16, wherein the step of controlling comprises pivoting the arm about a base element mounted to a fixed surface.

18. The method of claim 17, wherein the step of controlling comprises pivoting the arm about first and second axes.

19. The method of claim 18, wherein the step of controlling comprises varying an arm length of the arm.

20. The method of claim 16, wherein the step of controlling comprises pivoting the tool attachment relative to the arm.

21. The method of claim 20, wherein the step of controlling comprises rotating the collar about a tip member joined to the tip end of the shank.

22. The method of claim 21, further comprising rotating an actuator shaft to cause the collar to rotate about the tip member.

23. The method of claim 22, further comprising manually rotating a handle that is fixed to the actuator shaft.

24. The method of claim 16, further comprising driving rotation of the arm to cause a corresponding rotation of the tool attachment.

25. The method of claim 24, wherein the tool attachment comprises a socket, and the hardware component comprises one of a nut and a bolt, and the step of controlling comprises engaging the socket with the one of a nut and a bolt, and rotating the socket to cause fastening or unfastening of the one of a nut and a bolt.

26. The method of claim 16, wherein the plate is a divider plate in a steam generator.

27. An extension tooling apparatus, comprising:
a shank extending lengthwise along a shank axis between a handle end and a tip end;
a tip member joined to the tip end of the shank, the tip member extending between a proximal end adjacent the shank and a distal end opposite the proximal end;
a collar adjacent the distal end of the tip member, the collar for supporting a tool attachment so that positioning of the tool attachment is controllable by movement of the shank; and
an actuator shaft fixed to the collar and extending lengthwise of the shank to the handle end, the actuator shaft being adapted to rotate relative to the shank to cause corresponding rotation of the collar about the tip member.
